(19) United States
(12) Patent Application Publication
(10) Pub. No.: US 2008/0117545 A1
(43) Pub. Date: May 22, 2008

(54) Data storage system with field assist source

(75) Inventors: Sharat Batra, Wexford, PA (US); Werner Scholz, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/602,059

(22) Filed: Nov. 20, 2006

(51) Int. Cl. G11B 5/127

(52) U.S. Cl. 360/125.01

(57) ABSTRACT

A system including a recording head that includes a magnetic pole and a field assist source positioned adjacent the magnetic pole. The system further includes a recording medium positioned adjacent the recording head. In one aspect, the recording medium includes a magnetic recording layer wherein the magnetic recording layer has a damping value in the range of about 0.01 to about 0.20. In another aspect, the magnetic pole applies a write field to the recording medium at an angle in the range of about 15 degrees to about 30 degrees from an anisotropic axis of the magnetic recording layer and the field assist source applies a write assist field substantially in a plane perpendicular to the anisotropic axis of the magnetic recording layer. In another aspect, the field assist source has a spatial extent of about 12 nm to about 30 nm. In another aspect, the field assist source applies a circularly polarized write assist field substantially in a plane perpendicular to the anisotropic axis of the magnetic recording layer.

### FIELD OF THE INVENTION

The invention relates to data storage and, more particularly, relates to a data storage system having a field assist source.

### BACKGROUND INFORMATION

There are continuing efforts to increase storage densities of data storage systems. However, there are limitations that must be overcome to achieve further increases in storage densities. As an example, conventional magnetic recording currently faces difficulties at storage densities exceeding about 500 Gb/in². In order to achieve sufficient signal-to-noise (SNR) at these high storage densities, the grains of the recording media must be made extremely small. However, the thermal energy in these small grains can randomly reverse the magnetic state of a grain due to the superparamagnetic effect if the magnetic anisotropy of the grains is insufficient to prevent this reversal. Therefore, high density recording requires that the recording media have a high magnetic anisotropy. This in turn requires a recording head having the ability to produce a sufficiently high write field to switch the high magnetic anisotropy media. However, write field is limited due to, for example, magnetic moment limitations of materials for forming recording heads.

There is identified, therefore, a need for an improved data storage system that overcomes limitations, disadvantages, and/or shortcomings of known data storage systems.

### SUMMARY OF THE INVENTION

The invention meets the identified need, as well as other needs, as will be more fully understood following a review of this specification and drawings.

An aspect of the present invention is to provide a system including a recording head that includes a magnetic pole and a field assist source positioned adjacent the magnetic pole. The system further includes a recording medium positioned adjacent the recording head, the recording medium including a magnetic recording layer wherein the magnetic recording layer has a damping value in the range of about 0.01 to about 0.20. The field assist source generates an alternating current field that may be a radio frequency field in the range of about 10 GHz to about 40 GHz. The magnetic pole applies a write field to the recording medium at an angle in the range of about 15 degrees to about 30 degrees from an anisotropic axis of the magnetic recording layer. The field assist source may include a wire, a spin momentum transfer device, or a combination thereof.

Another aspect of the present invention is to provide a system including a recording medium having a magnetic recording layer and a recording head positioned adjacent the recording medium. The recording head includes a magnetic pole for applying a write field to the recording medium at an angle in the range of about 15 degrees to about 30 degrees from an anisotropic axis of the magnetic recording layer, and a field assist source positioned adjacent the magnetic pole for applying a write assist field substantially in a plane perpendicular to the anisotropic axis of the magnetic recording layer. The write assist field is co-located with the write field. The system may also include an additional magnetic pole, wherein the field assist source is positioned between the magnetic pole and the additional magnetic pole.

A further aspect of the present invention is to provide a system including a recording medium and a recording head positioned adjacent the recording medium. The recording head includes a magnetic pole for applying a write field to the recording medium and a field assist source positioned adjacent the magnetic pole for applying a write assist field to the recording medium. The field assist source has a spatial extent of about 12 nm to about 30 nm. The field assist source generates an alternating current field that may be a radio frequency field in the range of about 10 GHz to about 40 GHz. The system may also include an additional magnetic pole, wherein the field assist source is positioned between the magnetic pole and the additional magnetic pole.

These and other aspects of the present invention will be more apparent from the following description.

### BRIEF DESCRIPTION OF THE DRAWINGS

FIG. 1 is a pictorial representation of a data storage system that may utilize a recording medium constructed in accordance with the invention.

FIG. 2 is a view of an embodiment of a system constructed in accordance with the invention.

FIG. 3 is a schematic illustration of the embodiment set forth in FIG. 2.

FIG. 4 graphically illustrates an example of damping value dependence of the FMR in a recording medium.

FIG. 5 graphically illustrates the calculated ferromagnetic media resonance (FMR) frequency of a recording medium.

FIG. 6 graphically illustrates the relationship for switching the magnetization of a recording medium as a function of field angle, i.e. write field angle, in the presence of a linearly polarized RF field for a uniform granular recording medium.

FIG. 7 graphically illustrates reduction in switching field in accordance with the invention.

FIG. 8 graphically illustrates the change in magnetization from down state to up state for a linearly polarized field in the plane of the recording medium as a function of time under the presence of the RF field.

FIG. 9 graphically illustrates the normalized switching field required to switch magnetization for a recording medium for a linearly polarized and circularly polarized RF field as a function of intergranular exchange value.

FIG. 10 is a view of an additional embodiment of a system constructed in accordance with the invention.

FIG. 11 is a schematic illustration of the embodiment set forth in FIG. 10.

FIG. 12 is a view of an additional embodiment of a system constructed in accordance with the invention.

FIG. 13 is a view of an additional embodiment of a system constructed in accordance with the invention.

### DETAILED DESCRIPTION

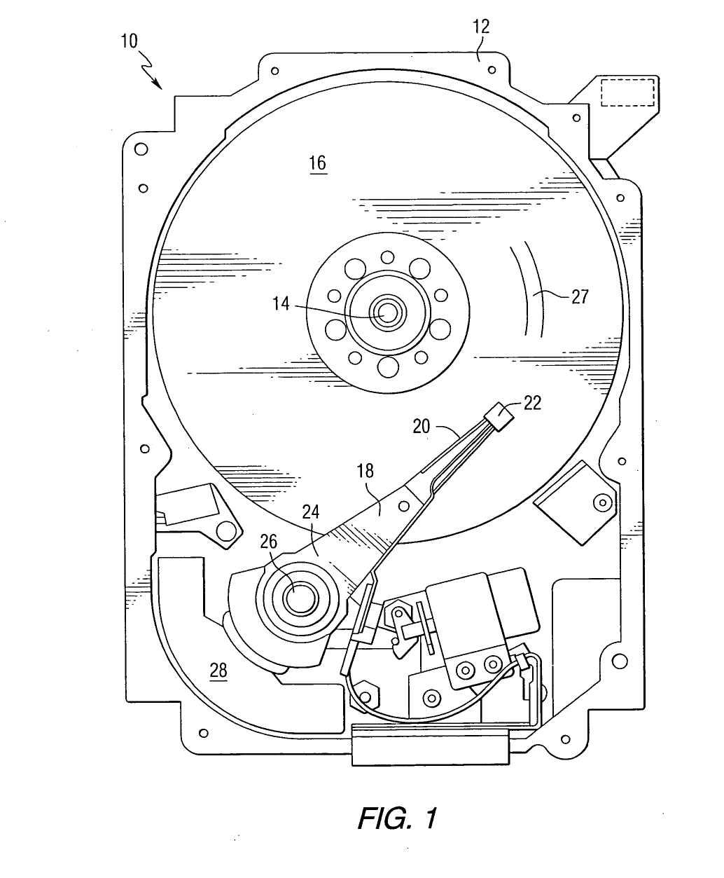

FIG. 1 is a pictorial representation of a data storage system 10 that can include aspects of this invention. The data storage system 10 includes a housing 12 (with the upper portion removed and the lower portion visible in this view) sized and configured to contain the various components of the data storage system 10. The data storage system 10 includes a spindle motor 14 for rotating at least one storage media, such as a magnetic recording medium 16, which may be a perpendicular, longitudinal and/or tilted magnetic recording medium, within the housing 12. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

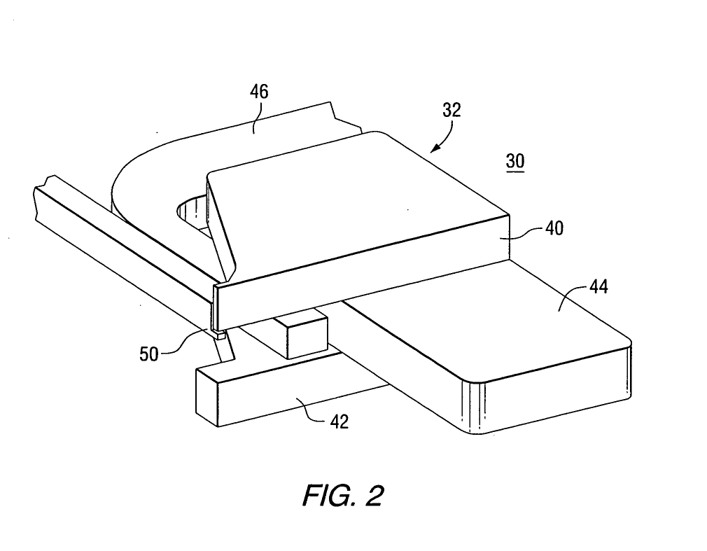

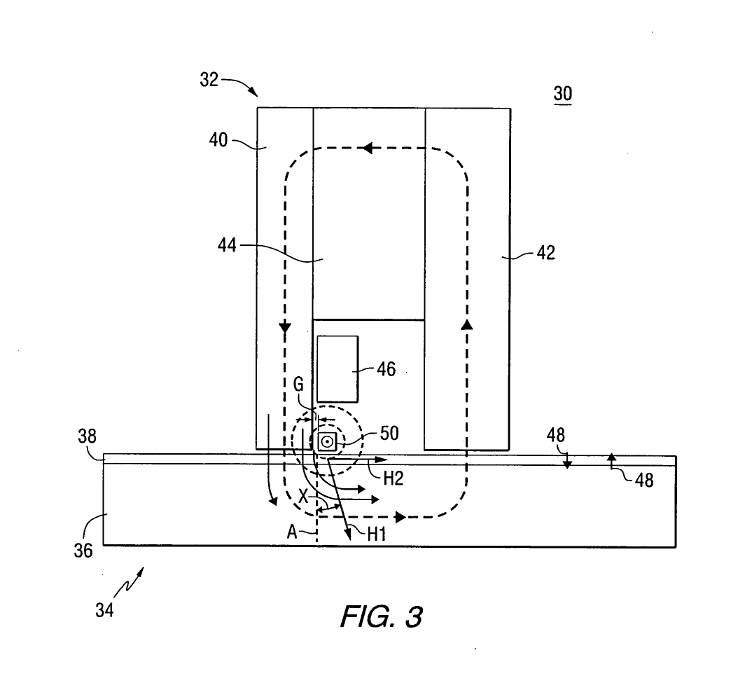

Referring to FIGS. 2 and 3, there is illustrated an embodiment of a system 30 constructed in accordance with the invention. The system 30 includes a magnetic recording head 32 positioned adjacent a magnetic recording medium 34 (only shown in FIG. 3) having a substrate 36 and a magnetic recording layer 38 formed thereon. The recording head 32 includes a first magnetic pole or write pole 40 and second magnetic pole or return pole 42 connected by a yoke 44.

The recording head 32 further includes an energizing coil 46 positioned adjacent the magnetic pole 40 to generate a magnetic field H1 that serves as write field for switching the perpendicularly oriented magnetic domains, illustrated by vertical arrows 48, of the recording layer 38. However, when the recording layer 38 is intended for high density data storage and the recording layer is formed of a material(s) having a sufficiently high magnetic anisotropy to support high storage densities, the field H1 may not be strong enough to switch the magnetization of the domains 48.

Accordingly, the recording head 32 of the present invention includes a field assist source such as, for example, a wire 50 that may be positioned between the poles 40 and 42 for generating a write assist field H2. The write assist field H2 generated by the field assist source, e.g., the wire 50, lowers the coercive force of an area of the recording layer 38 such that the write field H1 is sufficiently strong to switch the magnetization of a particular domain 48 in that area of the recording layer where the write assist field H2 is applied. It will be appreciated that the field assist source 50 is not required to be located between the poles 40 and 42, but can be located adjacent to either the trailing edge or leading edge of the write pole 40 depending on how the recording head is structured and where the writing of the data is taking place relative to the leading edge or trailing edge.

The field assist source may be any source capable of generating an alternating current (AC) field, such as, for example, a radio frequency (RF) field in the range of about 10 GHz to about 40 GHz to match the FMR frequency of the storage media. For example, the field assist source may be the wire 50 described herein, a device that utilizes a spin momentum transfer effect such as a current perpendicular to the plane (CPP) thin film structure, or any suitable device for applying a write assist field to the storage media.

In one embodiment of the invention illustrated in FIGS. 2 and 3, the wire 50 (or any other type field assist source that is utilized) is positioned closer to the write pole 40 than to the return pole 42 while maintaining a gap G (see FIG. 3) of about 5 nm to about 40 nm between the wire 50 and the write pole 40. By positioning the wire 50 closer to the write pole 40, the write field H1 from the write pole 40 and the write assist field H2 from the wire 50 can be co-located within the recording layer 38, as illustrated in FIG. 3, to most efficiently use the combined effects of the fields H1 and H2 to switch the magnetization of a particular domain 48.

In accordance with another aspect of the invention, the write field H1 is applied to the recording medium at an angle X (see FIG. 3) in the range of about 15 degrees to about 30 degrees from an anisotropic axis A of the magnetic recording layer 38. In addition, the write assist field H2 is applied substantially in the plane of the recording media 34, i.e. substantially in a plane perpendicular to the anisotropic axis A of said magnetic recording layer 38. This further enables the two fields H1 and H2 to be co-located to most efficiently use the combined effects of the fields H1 and H2 to switch the magnetization of a particular domain 48.

The write assist field H2 needs to be applied in the plane of the recording medium 34 at the resonance frequency of the recording medium. The resonance frequency is a function of recording medium parameters such as magnetic anisotropy H_{K}, demagnetization field 4πMₛ, and the applied write field from the recording head. Because the demagnetization field is changing as the individual grains of the recording layer 38 start to switch, the resonance frequency may need to be tuned.

It has been determined that the recording medium 34, and in particular the recording layer 38, needs to have good resonance properties. This requires that the recording layer 38 have a low damping value α, such as in the range of about 0.01 to about 0.20, such that it can maintain a strong resonance as defined by the line-width (proportionate to α) of the FMR of the recording medium 34.

In addition, the changing demagnetization field requires that the 4πMₛ of the media be kept small such that the system stays at near resonance during switching such that write assist field H2 energy is absorbed in the system which helps to switch the magnetization with less applied write field H1.

FIG. 4 illustrates an example of the damping value dependence of the FMR in a recording medium, such as recording medium 34 described hereinabove, for a recording medium having the parameters of H_{K}=22 kOe and Mₛ=400 emu/cc. Depending on the value of the damping, the system continues to oscillate about its final equilibrium position. As the damping value is increased, the oscillations of the spins are reduced in their amplitude and duration. Stated differently, these results imply that the resonance is weaker and broader as the α value is increased. This is also a reflection of how each grain will absorb energy when energized by the RF frequency. As the temperature is increased, the resonance peak also gets broader and weaker showing that the thermal process tends to destroy the coherence of the spin oscillation.

The resonance frequency of the recording medium not only depends on the intrinsic recording medium properties, but also on the applied head field, i.e. write field. For a perpendicularly oriented recording medium in an applied field H_{applied}, the resonance criterion is defined by the following relationship:

ω=γ(H_{applied}+H_{Keff}) (Equation 1)

where: ω=FMR resonance frequency

γ=gyromagnetic ratio

H_{Keff}=H_{K}−4πMₛ

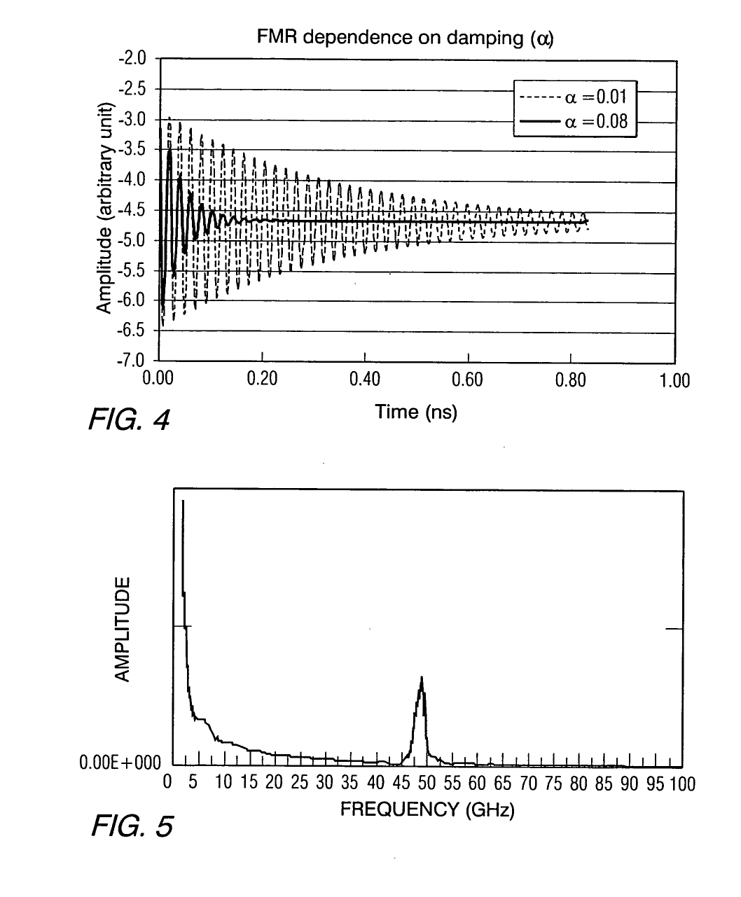

### FIG. 5 shows the calculated FMR resonance frequency of a recording medium with H_{K}=22 kOe and Mₛ=400 emu/cc at H_{applied}=100 Oe and at α=0.01. The resonance frequency shown in FIG. 5 is at about 47.5 GHz, as predicted by Equation (1).

For a granular recording medium, the resonance frequency will differ from the calculated value of the frequency as the grains are switched and the resultant demagnetization field and H_{Keff} is different, resulting in a higher resonance frequency. Therefore, a desired frequency for recording on a granular recording medium may be higher than the frequency calculated based on Equation 1. This also provides the reason why Ms of the media must be kept small so that the net effect of demagnetization on the unswitched grains does not change the resonance frequency substantially for efficient absorption of the RF energy during the switching.

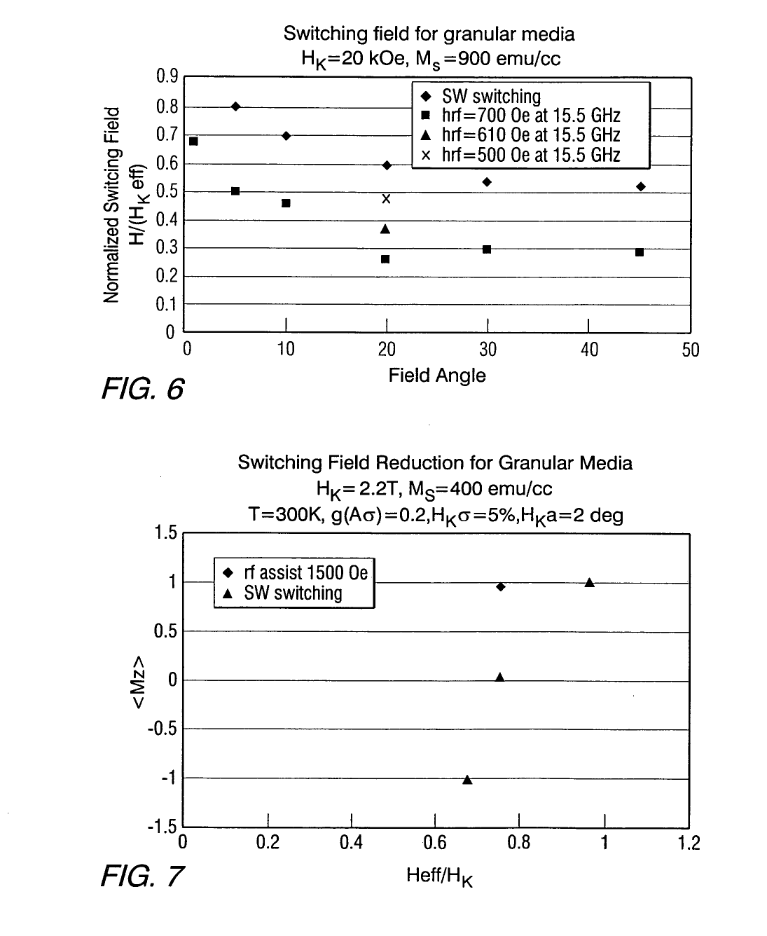

FIG. 6 shows the relationship for switching the magnetization of a recording medium as a function of field angle, i.e. write field angle, in the presence of a linearly polarized RF field for a uniform granular recording medium at a temperature of 0 K. For this model, a uniform field is applied at a specified angle to the recording medium. The Stoner-Wohlfarth (SW) field needed to switch all of the grains is illustrated. At higher field angles, the SW switching field is reduced and is equal to 0.5 H_{K} at a field angle of 45 degrees. Data storage systems typically rely on a recording head to produce a field equal to or greater than the SW field for writing transition on the media. According to the present invention, when an RF field is turned on at the appropriate frequency as discussed hereinabove, a significant reduction in the switching field is observed. The reduction in the switching field is a function of the magnitude of the applied RF field and damping value □. The recording medium parameters for the results illustrated in FIG. 6 are H_{K}=20 kOe, 4πMₛ=900 emu/cc, and a damping constant α=0.02.

Referring to FIG. 7 and having defined the need for a low damping value and a low Mₛ for the recording medium, and defined a way to model the resonance frequency in the presence of an applied field and defined that there is significant reduction in the switching field in the presence of an RF field when the DC bias field is applied at an angle of 20 degrees, these findings are illustrated by applying a DC and an RF field on a granular recording medium. At a frequency of 34 GHz, for a recording medium with H_{K}=2.2 T, Ms=400 emu/cc, a grain area distribution g(Aσ) of 20%, H_{K}σ distribution of 5% and angular dispersion H_{K}a of 2 degrees at 300 K, it was determined that in the presence of an in-plane RF field, the magnetization could be switched at H_{eff}/H_{K}=0.75 as opposed to SW switching at H_{eff}/H_{K}=1.0, as shown in FIG. 7. The DC field required to switch the media is 0.385 H_{K}. This is a significant reduction in the recording field. In FIG. 7, the vertical axis is labeled “<Mz>” which refers to the average z component of the magnetization in the media wherein +1 means that magnetization is pointing in one direction and −1 means that magnetization is switched.

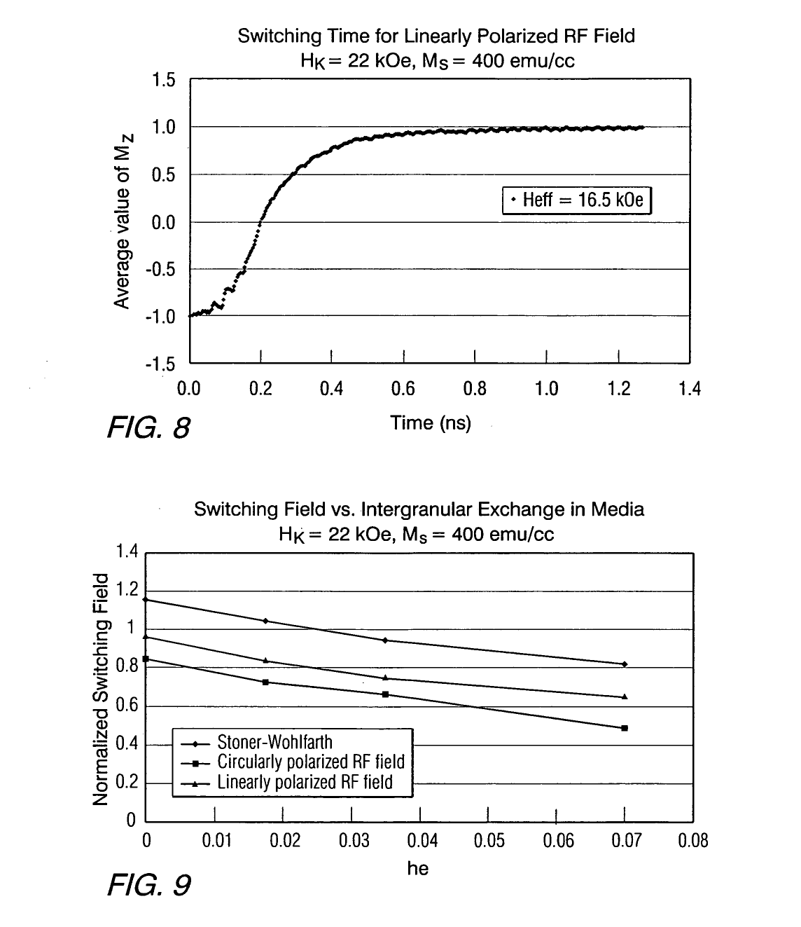

The spatial extent of the RF source also plays an important part in the reduction of the switching field for a granular recording medium. FIG. 8 shows the change in magnetization from down state to up state for a linearly polarized RF field in the plane of the recording medium as a function of time under the presence of the RF field. As shown in FIG. 8, the time it takes the magnetization to switch is about 0.6 ns. Depending on the disk velocity (for example 20 m/s for a desktop disc drive to 50 m/s for a server class disc drive), the spatial extent of the RF source must be in the range of about 12 nm to about 30 nm for the recording head and recording medium parameters used. This also has a significant implication for the type of RF source that can be utilized. For example, at a lower velocity a spin momentum transfer source may be used, while at a higher velocity either a wire source or a combination of wire and spin momentum transfer source may be used to provide the RF field for a significant reduction in switching field. As described herein, the write field must be co-located with the RF assist field to observe a reduction in switching field.

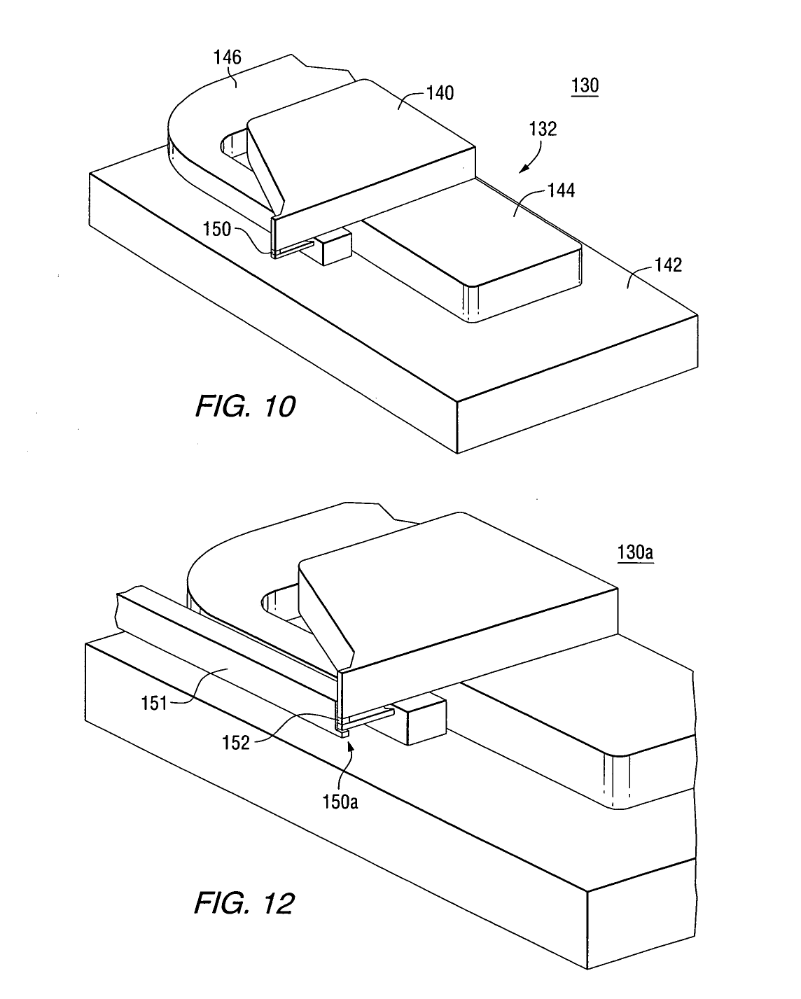

FIG. 9 illustrates the normalized switching field required to switch magnetization for a recording medium for a linearly polarized and a circularly polarized rotating RF field as a function of intergranular exchange value in the media. For all values of intergranular exchange field values considered, the linearly polarized and circularly polarized RF assisted recording requires less total switching field than the SW switching.

As discussed herein, the invention provides for low damping in the recording layer. Intrinsic damping in a ferromagnetic material results from the spin-orbit coupling. A class of materials using doped vanadium has been shown to reduce damping. In addition, minimizing defects in the recording layer minimizes extrinsic damping. Therefore, a recording media in accordance with the invention may be made from a multilayer structure of Co/Pt alloys or Fe/Pt alloys with a suitable addition of elements such as, for example, vanadium.

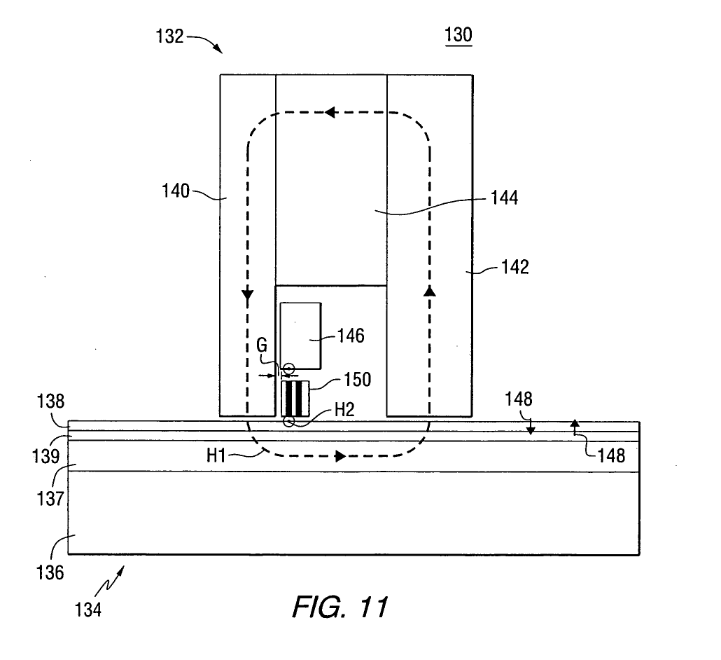

Referring to FIGS. 10 and 11, there is illustrated an additional embodiment of a system 130 constructed in accordance with the invention. The system 130 includes a magnetic recording head 132 positioned adjacent a magnetic recording medium 134 (only shown in FIG. 11) having a substrate 136, a soft underlayer (SUL) 137, an intermediate layer 139, and a magnetic recording layer 138 formed thereon. The recording head 132 includes a first magnetic pole or write pole 140 and second magnetic pole or return pole 142 connected by a yoke 144.

The recording head 132 further includes an energizing coil 146 positioned between the poles 140 and 142 to generate a magnetic field H1 that serves as write field for switching the perpendicularly oriented magnetic domains, illustrated by vertical arrows 148, of the recording layer 138. However, when the recording layer 138 is intended for high density data storage and the recording layer is formed of a material(s) having a sufficiently high magnetic anisotropy to support high storage densities, the field H1 may not be strong enough to switch the magnetization of the domains 148.

Accordingly, the recording head 132 of the present invention includes a field assist source 150 that may be positioned between the poles 140 and 142 for generating a write assist field H2. It will be appreciated that the field assist source 150 is not required to be located between the poles 140 and 142, but can be located adjacent to either the trailing edge or leading edge of the write pole 140 depending on how the recording head is structured and where the writing of the data is taking place relative to the leading edge or trailing edge.

The write assist field H2 generated by the field assist source 150 lowers the coercive force of an area of the recording layer 138 such that the write field H1 is sufficiently strong to switch the magnetization of a particular domain 148 in that area of the recording layer where the write assist field H2 is applied. In this embodiment, the field assist source 150 may be, for example, a device that utilizes a spin momentum transfer effect such as a current perpendicular to the plane (CPP) thin film structure.

In the embodiment of the invention illustrated in FIGS. 10 and 11, the field assist source 150, i.e. the CPP thin film structure (or any other type field assist source that is utilized), is positioned closer to the write pole 140 than to the return pole 142 while maintaining a gap G (see FIG. 11) of about 5 nm to about 40 nm between the field assist source 150 and the write pole 140. By positioning the field assist source 150 closer to the write pole 140, the write field H1 from the write pole 140 and the write assist field H2 from the field assist source 150 can be co-located within the recording layer 138 to most efficiently use the combined effects of the fields H1 and H2 to switch the magnetization of a particular domain 148.

FIG. 12 illustrates another embodiment of a system 130a, similar to the embodiment illustrated in FIGS. 10 and 11, except that the field assist source 150a includes a combined wire 151 and CPP stack 152 for generating the write assist field H2. It will be appreciated that various combinations of field assist sources may be used in accordance with the invention.

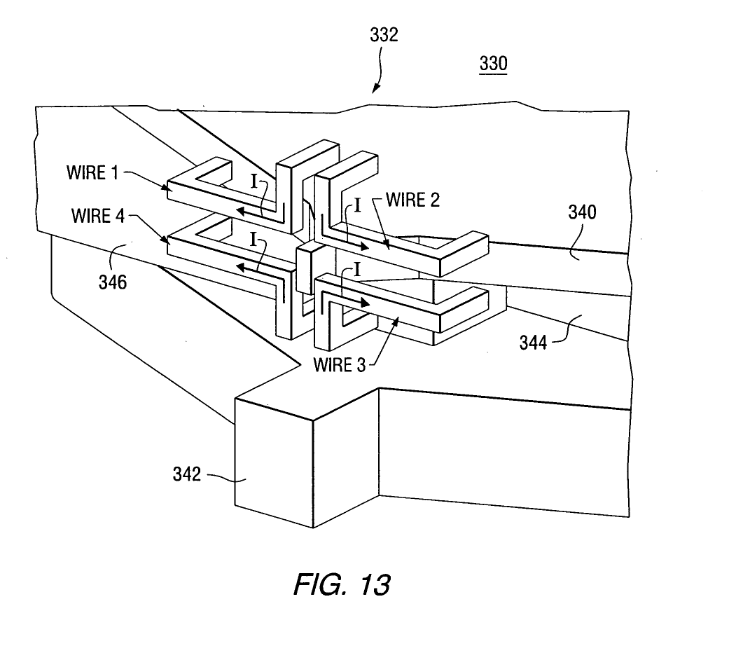

FIG. 13 illustrates another embodiment of a system 330 in accordance with the invention. The system 330 includes a magnetic recording head 332 positioned adjacent a magnetic recording medium (not shown). The recording head 332 includes a first magnetic pole or write pole 340 and second magnetic pole or return pole 342 connected by a yoke 344. The recording head 332 further includes an energizing coil 346 positioned between the poles 340 and 342 to generate a magnetic write field. In this embodiment, a four wire structure is provided to generate a circularly polarized RF field. Wires labeled 1 and 3 share a common ground and in-phase current source (not shown) to generate a current I in the wires, while wires 2 and 4 share a common ground and in-phase current source (not shown) to generate a current I in the wires such that the two current sources are 90 degrees out of phase to each other. This configuration generates a circularly polarized RF field along with the low frequency DC write field from the write pole 340. These set of wires are physically offset so that the high frequency circularly polarized field is co-located with the low frequency write field such that the low frequency write field makes an angle of about 15 to about 30 degrees at the recording medium. It will be appreciated that the circularly polarized RF field is provided to rotate in the same direction as the natural procession direction of the magnetization of the domains in the recording medium to be switched.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims. In addition, it will be appreciated that aspects of the invention may be utilized in any type of system for storing data where the invention may be useful, and that the invention is not limited to the specific systems illustrated and described herein.

What is claimed is:

1. A system, comprising:
a recording head, comprising:
a magnetic pole; and
a field assist source positioned adjacent said magnetic pole; and
a recording medium positioned adjacent said recording head, said recording medium including a magnetic recording layer wherein said magnetic recording layer has a damping value in the range of about 0.01 to about 0.20.

2. The system of claim 1, wherein said field assist source generates an alternating current field.

3. The system of claim 2, wherein said alternating current field is a radio frequency field in the range of about 10 GHz to about 40 GHz.

4. The system of claim 1, wherein said recording medium includes a soft magnetic underlayer adjacent said magnetic recording layer.

5. The system of claim 1, further comprising an additional magnetic pole, and wherein said field assist source is positioned between said magnetic pole and said additional magnetic pole.

6. The system of claim 1, wherein said magnetic pole applies a write field to said recording medium at an angle in the range of about 15 degrees to about 30 degrees from an anisotropic axis of said magnetic recording layer.

7. The system of claim 6, wherein said field assist source applies a write assist field to said recording medium that is substantially in a plane perpendicular to said anisotropic axis of said magnetic recording layer.

8. The system of claim 7, wherein said write assist field is a linearly polarized field or a circularly polarized field.

9. The system of claim 7, wherein said write assist field is co-located with said write field.

10. The system of claim 1, further comprising an additional magnetic pole, and wherein said field assist source is closer to said magnetic pole than to said additional magnetic pole.

11. The system of claim 1, wherein said field assist source includes a wire, a spin momentum transfer device, or a combination thereof.

12. The system of claim 1, wherein said field assist source has a spatial extent of about 12 nm to about 30 nm.

13. A system, comprising:
a recording medium having a magnetic recording layer; and
a recording head positioned adjacent said recording medium, said recording head comprising:
a magnetic pole for applying a write field to the recording medium at an angle in the range of about 15 degrees to about 30 degrees from an anisotropic axis of the magnetic recording layer; and
a field assist source positioned adjacent said magnetic pole and for applying a write assist field substantially in a plane perpendicular to said anisotropic axis of said magnetic recording layer.

14. The system of claim 13, wherein said write assist field is a linearly polarized field or a circularly polarized field.

15. The system of claim 13, wherein said write assist field is co-located with said write field.

16. The system of claim 13, further comprising an additional magnetic pole, and wherein said field assist source is positioned between said magnetic pole and said additional magnetic pole.

17. The system of claim 13, wherein said field assist source has a spatial extent of about 12 nm to about 30 nm.

18. A system, comprising:
a recording medium; and
a recording head positioned adjacent said recording medium, said recording head comprising:
a magnetic pole; and
a field assist source positioned adjacent said magnetic pole for applying a write assist field to said recording medium, said field assist source having a spatial extent of about 12 nm to about 30 nm.

19. The system of claim 18, wherein said field assist source generates an alternating current field.

20. The system of claim 18, further comprising an additional magnetic pole, and wherein said field assist source is positioned between said magnetic pole and said additional magnetic pole.
